(19) United States
(12) Patent Application Publication
(10) Pub. No.: US 2026/0228619 A1
(43) Pub. Date: Aug. 6, 2026

(54) FORECASTING DEVICE TIME SERIES DATA DURING A COLD-START PERIOD

(71) Applicant: HEWLETT PACKARD ENTERPRISE DEVELOPMENT LP, Spring, TX (US)

(72) Inventors: Mantej Singh Gill, Bangalore (IN); Arun Mahendran, Bangalore (IN); Rajendra Babu Godla, Bangalore (IN); Tarun Khaneja, Bangalore (IN); Shaunak Sensarma, Bangalore (IN); Mahalakshmi L, Bangalore (IN)

(21) Appl. No.: 19/185,675

(22) Filed: Apr. 22, 2025

(30) Foreign Application Priority Data
Jan. 31, 2025 (IN) 202541008169

(51) Int. Cl. G06N 20/00

(52) U.S. Cl. CPC G06N 20/00

(57) ABSTRACT

Systems and methods are provided for reducing or eliminating a cold start period experienced with a first machine learning model by implementing a second machine learning model to generate forecasts during the first model's cold start period. The second machine learning model may be trained on data that is collected absent the new device or application, and generate forecasts that may be anonymized and generalized for several environments.

### BACKGROUND

New devices and applications are constantly added to active computer environments. The devices may perform operations as soon as they are activated or turned on. As operations and electronic messages are transmitted, the devices and applications may be identified by other devices and the operations they perform may start forming a pattern of operations that are detectable within the network.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is a block diagram of an example compute component for forecasting device time series data during a cold-start period, in accordance with implementations of the present disclosure.

FIG. 2 illustrates a forecasting process for time series data during a cold-start period, in accordance with some examples described herein.

FIG. 3 illustrates a forecasting process for time series data during a cold-start period, in accordance with some examples described herein.

FIG. 4 illustrates a comparison of machine learning models, in accordance with some examples described herein.

FIG. 5 illustrates a comparison of machine learning models, in accordance with some examples described herein.

FIG. 6 is an example computing component that may be used to implement various features discussed herein.

FIG. 7 is a computing component that may be used to implement examples of the disclosed technology.

The figures are not exhaustive and do not limit the present disclosure to the precise form disclosed.

### DETAILED DESCRIPTION

Some traditional systems may implement a monitoring device in a computer environment. The monitoring device may receive data from the devices in the computer environment and detect patterns of their operations and data transmissions. To detect the patterns, the monitoring device may need to receive a threshold amount of data from the devices (e.g., over a period of time). When new devices are added, the monitoring device may be configured to identify the pattern of operations and data transmissions of the new device only after the threshold is exceeded. This is referred to as the “cold start” period of monitoring the new device.

In some traditional systems, the monitoring device may be unable to initially generate forecasts for the particular computer environment during the “cold start” period. The model may be configured to generate the forecast after the monitoring device receives and trains a machine learning model with the threshold amount of data. Eventually, the model may be trained using the data generated by the new device or application and the model can generate forecasts that are tuned to the particular computer environment. The traditional system can then forecast future patterns from the same device and respond to those actions quickly or before they even occur. Until the model is trained, traditional systems may provide generalized predictions rather than particular predictions that are tuned to the new device.

Examples of the current system may reduce or eliminate the cold start period experienced in traditional systems by implementing an additional machine learning model for forecasting device time series data for a new device/application in a computer environment. A first machine learning model may be a time series foundational model (TFM) that is trained on data outside of the computer environment and generalizes forecasting for the new device. The monitoring device may concurrently or additionally train a second machine learning model using data generated by the new device in the computer environment over a time period while the first model is generating the forecasting. The second machine learning model may outperform the first machine learning model (e.g., in forecasting accuracy) and the monitoring device can switch to utilizing the second machine learning model instead of the first machine learning model.

Examples of the current system may execute both a first machine learning model and a second machine learning model in a computer environment that forecasts operations of a new device or application at different time periods. The first machine learning model may be executed absent fine tuning the model to the time series data in the computer environment, including time series data generated by the new device or application, in order to generate forecasting quickly.

When the first machine learning model is initially activated, the second machine learning model may be unusable for forecasting (during its cold start period), in part because it has not been trained to generate forecasts. The second machine learning model may be usable to generate forecasts after it has been tuned/trained using time series data from the new device. As such, the first machine learning model may be introduced to the network to be deployed faster than the second machine learning model (e.g., absent tuning the first model to the particular data in the computer environment). In this sense, the first machine learning model is configured to generate forecasting during the second machine learning model's cold start period.

In some examples, the first machine learning model may be trained on data that is collected absent the new device or application in the other environments. This can allow the first machine learning model to generate forecasting that may be anonymized and generalized for several environments, rather than generating no forecasting during the cold start period before the second machine learning model is trained for the specific computer environment.

In response to receiving time series data associated with the new device or application, the current system may initiate several actions. For example, the current system may split the time series data into a first portion of time series data and a second portion of time series data. The first portion of time series data may be provided to the first machine learning model for forecasting operations of the new device or application. The first portion of time series data may also be provided to a second machine learning model data to concurrently train the model while the first machine learning model is forecasting the operations of the new device or application.

The forecasting generated by the two models may be compared. For example, the current system can provide the second portion of the initial time series data to both the first machine learning model and the second machine learning model. This second portion may be split from the initial time series data, so that the second portion of data is not used to train the second machine learning model and overfit the forecast. The comparison may be implemented, for example, using a Root-Mean-Square Deviation (RMSE) to identify the differences in accuracy of the two models.

In response to the comparison, the system can utilize the second machine learning model to forecast new operations of the new device or application and stop using the first machine learning model. For example, in response to exceeding an accuracy threshold or in response to exceeding the accuracy of the forecast generated by the first machine learning model, the second machine learning model may be used by the current system to generate forecasts for the computer environment.

Technical benefits of the current system are numerous. For example, the system can reduce the amount of down time that traditional systems experience in providing forecasts of operational data of new devices, thus reducing or eliminating the cold start period altogether. Additionally, the accuracy of the forecasts of the second model improve over time. Since the first model is generating the forecasts while the second model is training, the end user can benefit from the forecasting throughout the lifecycle of the new device or application, absent the traditional cold start period.

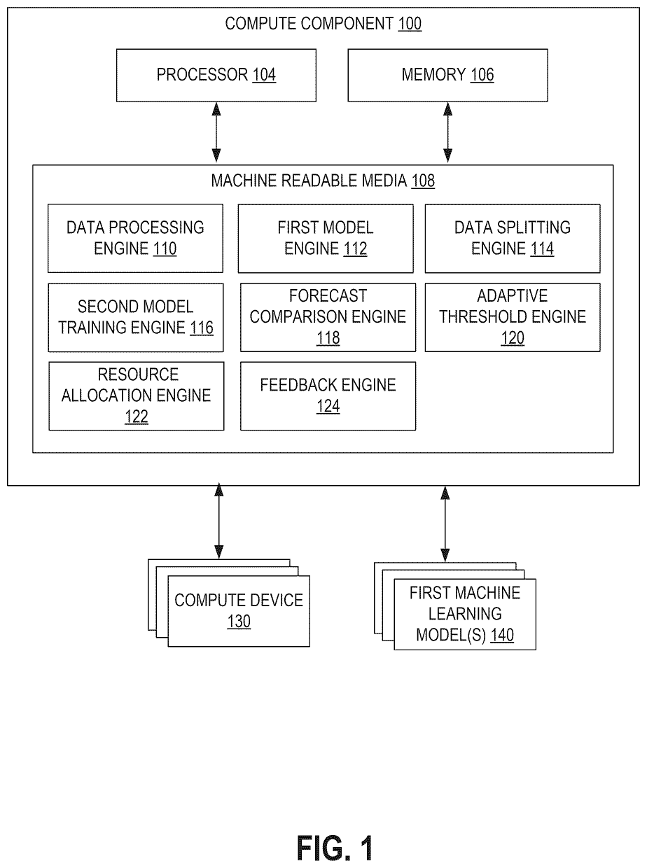

FIG. 1 is a block diagram of an example compute component for forecasting device time series data during a cold-start period. In this example, the environment comprises compute component 100 that is communicable with (e.g., via wired or wireless communication connection) compute device(s) 130 and first machine learning model(s) 140.

Compute component 100 may be a server computer, a controller, or any other similar computing component capable of processing and transmitting data via network communications to the other devices. In the example of FIG. 1, compute component 100 comprises processor 104, memory 106, and machine readable media 108.

Processor 104 may be one or more central processing units (CP Us), semiconductor-based microprocessors, and/or other hardware devices suitable for retrieval and execution of instructions stored in machine-readable storage medium 108. Processor 104 may fetch, decode, and execute instructions to control processes or operations for forecasting device time series data during a cold-start period. As an alternative or in addition to retrieving and executing instructions, processor 104 may include one or more electronic circuits that include electronic components for performing the functionality of one or more instructions, such as a field programmable gate array (FPGA), application specific integrated circuit (ASIC), or other electronic circuits.

Memory 106 may comprise random-access memory (RAM) or other dynamic memory for storing information and instructions to be executed by processor 104. Memory 106 might also be used for storing temporary variables or other intermediate information during execution of instructions to be executed by processor 104. Memory 106 may also comprise a read only memory (“ROM”) or other static storage device coupled to a bus for storing static information and instructions for processor 104.

Machine readable media 108 may comprise one or more interfaces, circuits, and modules for implementing the functionality discussed herein. Machine readable media 108 may carry one or more sequences of one or more instructions that can be executed by processor 104. Thus, machine-readable storage medium 108 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 108 may be a non-transitory storage medium, where the term “non-transitory” does not encompass transitory propagating signals. Such instructions embodied on machine readable media 108 may enable compute component 100 to perform features or functions of the disclosed technology as discussed herein. For example, the interfaces, circuits, and modules of machine readable media 108 may comprise, for example, data processing engine 110, first model engine 112, data splitting engine 114, second model training engine 116, forecast comparison engine 118, adaptive threshold engine 120, resource allocation engine 122, and feedback engine 124. Any number or combination of these components may be included with compute component 100 or may be implemented remotely from compute component without diverting from the essence of the disclosure.

Data processing engine 110 is configured to receive time series data of a compute device or application, including compute device 130. The time series data may correspond with an existing device in the computer environment or a new device in the computer environment. In some examples, the time series data may correspond with operations and executions of machine readable instructions associated with a single software application that is executed by a processor at compute device 130.

Data processing engine 110 is also configured to receive historical time series data, including telemetry data. For example, the data may be represented as:

$$D = \{ ( {t}_{i , j} , {v}_{i , j} ) \vert i = 1 , 2 , ... , N \}$$

Where t_{i,j} are timestamps and v_{i,j} are the corresponding time series data values for the j-th compute device. The value “i” may index the data points and “N” may be the total number of data points for each compute device.

The time series data may be received through a data collection process. In some examples, the time series data are collected via a management process located at compute device 130 that pulls the time series data from processes and or a monitoring agent operating at the compute device. The management process may comprise an Application Programming Interface (API) that pulls the data. In other examples, an agent or other software program that is installed on compute device 130 may transmit/push the time series data from compute device 130 to data processing engine 110.

In some examples, the time series data may comprise telemetry data associated with compute device 130 in a computer environment, including data associated with the memory bus, Graphics Processing Unit (GPU), Central Processing Unit (CPU), or input/output (I/O), to list a few. In some examples, time series data may comprise temperature, humidity, or other sensor-detected values in the computer environment. The time series data may be effected by seasonality or other cyclical changes that are detectable in the data output generated by compute device 130.

Data processing engine 110 is also configured to pre-process the data. The pre-processing may clean the received data from compute device 130. The pre-processing may remove noises, handle missing values, standardize formatting, and/or the like. In some examples, the pre-processing may prepare the data as input to additional processing by the machine learning model(s).

Other processes may be implemented as well. For example, data processing engine 110 is also configured to include seasonal decomposition to isolate trends in the data, Min-Max Scaling for neural networks, or outlier detection/imputation to handle anomalies.

First model engine 112 is configured to receive a first machine learning model that has been trained by an external computer environment. For example, the first machine learning model may be trained to fit generalized time series data using optimization techniques such as gradient descent (for machine learning and deep learning models) or maximum likelihood estimation (for other models). For deep learning models, the training process may determine a number of layers, units per layer, and other elements of the architecture design of the first machine learning model. In some examples, the training process may also implement regularization (e.g., dropout).

The first machine learning model correspond with various types of models, including a time series foundational model (TFM). The time series foundational model may be trained to identify patterns, connections, and structures in data. The first machine learning model may be considered foundational based on the model's ability to be modified or fine-tuned for tasks or domains with minimal additional training. In some examples, the first machine learning model may be a zero-shot learning (ZSL) model. The first machine learning model may be trained to recognize and categorize objects or concepts absent receiving data associated with those categories or concepts beforehand. This may allow the first machine learning model to be tuned/developed for specific tasks.

In some examples, first model engine 112 may implement hyperparameter tuning on the first machine learning model. During hyperparameter tuning, the training process may optimize hyperparameters, such as learning rates for gradient-based models or lag/seasonality parameters, using processes like grid search or Bayesian optimization.

In some examples, first model engine 112 may optimize an objective during the training process. The objective may correspond with minimizing a loss function, such as Mean Squared Error (MSE) or Mean Absolute Error (MAE), to generate forecasts as accurately as possible and outperform other machine learning models that are also generating forecasts of the data.

In some examples, first model engine 112 may receive a pre-existing machine learning model from an external source, illustrated as first machine learning model(s) 140. The first machine learning model may correspond with a foundation model (e.g., machine learning or deep learning model) that is trained on vast datasets so it can be applied across a wide range of use cases. Illustrative examples of the first machine learning model may include, for example, Lag-LLAMA (e.g., an open source time series foundational model), LLaVa (e.g., a multimodal model), Qwen-VL (e.g., a multimodal model), MOMENT (e.g., time-series classifier that can be used without training), Chronos (e.g., multiple pre-trained models), or Moirai (e.g., a universal model for time series forecasting), to name a few.

First model engine 112 is also configured to execute/utilize the first machine learning model in a computer environment. The first machine learning model may forecast operations of a new device or application that is activated in the computer environment. In some examples, the first machine learning model may generate a forecast while the second machine learning model is receiving data from compute device 130 (e.g., by data processing engine 110) and training a second machine learning model to generate the forecast (e.g., by second model training engine 116). The first machine learning model may generate the forecast during the cold start period of the second machine learning model until, for example, the accuracy of the second model exceeds the accuracy of the first model.

Data splitting engine 114 is configured to split the time series data into a first portion of time series data and a second portion of time series data. The splitting may be initiated in response to executing the first machine learning model (e.g., by first model engine 112) and receiving time series data (e.g., by data processing engine 110). For example, the time series data may be split between a first portion of time series data and a second portion of time series data that is used to train the second machine learning model. In another example, the time series data may be split between a first portion of time series data that is provided to the first machine learning model and a second portion of time series data that is provided to the second machine learning model.

Various splitting processes may be implemented. For example, thirty days of time series data associated with compute device 130 may be received and initially split into training, testing, and validation data. In another example, the amount of data may be open-ended and configurable by the user (e.g., stored in a profile). In some examples, the time series data may be split eighty-percent for training and twenty-percent for validation, or the data may be split sixty-percent for training, twenty-percent for testing, and twenty-percent for validation. In some examples, the time series data may be split using different cross-validation techniques that depend on the second machine learning model that is being trained/implemented.

As an illustrative example, when the second machine learning model is a regression model, the data may be split eighty-percent training and twenty-percent testing. Comparatively, when the second machine learning model is a Neural Hierarchical Interpolation for Time Series (NHITS) model (e.g., with an MLP-based deep neural architecture and backward and forward residual links), the training may include cross-validation, where the data are split sequentially with the training set consisting of earlier data points and the test set consisting of subsequent data points.

In some examples, data splitting engine 114 may roll a training set window forward over time to split the time series data. The portions of data may correspond with the time series data within the window boundaries. The split data may overlap or occur in different portions of the time series data.

Splitting processes may be selected for training, validation, and testing datasets based on dynamic or static profile determinations or the particular computing environment. For example, a fixed value related to percentage splits may be a straight-forward computational process that does not add a significant amount of overhead processing, yet the process may not capture sequential dependencies in time series data. In another example, the split may implement a rolling window process. The rolling window may be more robust than the fixed value percentage and may be implemented for sequential data, yet the process may be computationally expensive. In another example, a sliding window process may recommended for generalization.

Data splitting engine 114 is also configured to provide the first portion of time series data to the first machine learning model for forecasting the operations of the new device or application. In this example, the same data are provided to the first machine learning model and to the second machine learning model in order to generate forecasts of the same data by the two models.

Second model training engine 116 is configured to train a second machine learning model using the first portion of the time series data concurrently with the first machine learning model forecasting the operations of the new device or application. For example, the same portion of the time series data may be provided to both the first and second machine learning models to tune/improve the forecasting produced by each model.

In this example, the time series data may be pre-processed (by data processing engine 110) and provided as input to train the second machine learning model by second model training engine 116. The training process may create features from the time series data, including lag features that represent the historical values of the series, such as lag-1, lag-2, and so on. The historical values and features can be used to forecast future values. In some examples, the training process may determine a rolling window of time and iteratively calculate the moving average or the moving standard deviation.

The training process may use the portion of the data determined by data splitting engine 114 to train the second machine learning model with the identified features. For example, the second machine learning model may receive a fixed window of time series data (by data splitting engine 114), on which it is trained (by second model training engine 116), before the accuracy is tested/compared on the next window/portion (by forecast comparison engine 118). The sliding window can simulate how the model would perform on future unseen data. The training set may grow with each iteration, or remain the same size, as the test set moves forward in time.

Forecast comparison engine 118 is configured to compare forecasts of the second portion of data generated by the first machine learning model and the second machine learning model. Various features or metrics may also be analyzed, including metrics like MAPE (e.g., for interpretability) and F1 Score or Precision/Recall (e.g., for anomaly detection).

The forecast performance may be evaluated in various ways in the process of determining whether models outperform each other. For example, the forecast of time series data of compute device 130 can be compared to historical data to determine whether the forecast was accurate. In another example, the evaluation of the forecast performance can be compared between multiple models to determine which model is more accurate to the actual time series data as it is received from compute device 130. In another example, the forecasts can be compared using real-time streaming validation or scenario testing for hypothetical workload patterns. Any of these forecast performance approaches may help measure robustness and improve reliability of the models.

Adaptive threshold engine 120 is configured to determine an initial threshold estimation. For each compute device 130, denoted as “j,” an initial estimate may be determined for Time X, denoted as “X_{0,j}.” The initial estimate may utilize historical time series data up to X_{0,j} for each compute device 130. The first machine learning model and the second machine learning model may be trained using the historical time series data up to X_{0,j} for compute device 130.

The forecasts may be compared using forecast comparison engine 118. For example, the comparison process may determine a Root Mean Square Error (RMSE) for both TFMs and ML models at X_{0,j}, denoted by RMSE_{TFM}(X_{0,j}) and RMSE_{ML}(X_{0,j}). Other methods of comparing the forecasts may be implemented as well. For example, forecast comparison engine 118 may utilize metrics such as Mean Absolute Error (MAE) or Mean Absolute Percentage Error (MAPE) to quantify the model's accuracy.

In some examples, the accuracy values of forecasts are compared by forecast comparison engine 118. For example, when the data are split into portions, the accuracy value of the first portion of the data may be compared with the accuracy value of the second portion of data. Either or both of these values may be compared with a threshold value. In response to the accuracy value fail exceeding the threshold value, the model corresponding with the accuracy value can be implemented for forecasting.

In response to the accuracy value failing to exceed the threshold value, adaptive threshold engine 120 can increase the threshold time for initiating a second comparison of the forecasts. In some examples, the threshold time can be exponentially increased for reevaluations of the accuracy value. This process can reduce computational overhead while allowing the second machine learning model more time for improvement of its forecasting output and ensuring efficient reevaluation cycles in order to outperform the first machine learning model.

In response to evaluating/comparing the forecast performance for each compute device 130, adaptive threshold engine 120 may adjust X_{0,j} for each compute device 130 based on the performance comparison.

Adaptive threshold engine 120 is also configured to determine an adaptive threshold estimation. For example, X_{0,j} may be adjusted for each compute device 130 based on the performance comparison using the following formula:

$${X}_{0 , j} ← arg {min}_{x} ( {RMSE}_{TFM} ( X ) - {RMSE}_{ML} ( X ) )$$

The final X₀ may be determined. In some examples, the final X₀ is determined to be the average of the X₀ values from each compute device 130 using the following formula:

$${X}_{0}^{final} = \frac{1}{M} {\sum }_{j = 1}^{M} {X}_{0 , j}$$

Where M is the number of servers and X_{0,j} is the initial X₀ for the j-th compute device 130. In some examples, the adaptive threshold may be implemented in the active computer environment. Adaptive threshold engine 120 can implement the TFM for forecasting of compute device 130 to the final X₀.

In some examples, Time X is initially estimated using historical data for similar devices to compute device 130 and is dynamically adjusted based on various performance metrics, like RMSE and MAPE. Alternative processes for determining Time X without diverting from the essence of the disclosure.

In some examples, the TFM with the adaptive threshold may be implemented in a phased rollout process for forecasting of compute device 130 to the final X₀. The monitoring device may continuously monitor forecasting performance after the initial X₀ by evaluating RMSE_{TFM}(X) and RMSE_{ML}(X) for each compute device 130.

Resource allocation engine 122 is configured to utilize the second machine learning model to forecast new operations of the new device or application. The utilization of the second machine learning model may be initiated in response to the comparison between forecasts generated by the first machine learning model and the second machine learning model.

Feedback engine 124 is configured to receive feedback from users of compute device 130. The feedback may comprise an additional assessment or comparison of the forecasting. In some examples, feedback mechanisms include user-provided accuracy feedback, automatic performance monitoring using metrics like RMSE and MAPE, or iterative refinement of the second machine learning model through one or more feedback loops.

In some examples, the feedback may be used to iteratively refine X using the following formula:

$$X ← f ( feedback , X )$$

Feedback engine 124 is also configured to ensure alignment with the system requirements and update the process described herein. In some examples, alignment is ensured using version control systems for model updates, automated validation tests, or predefined benchmarks to verify consistency and performance improvements.

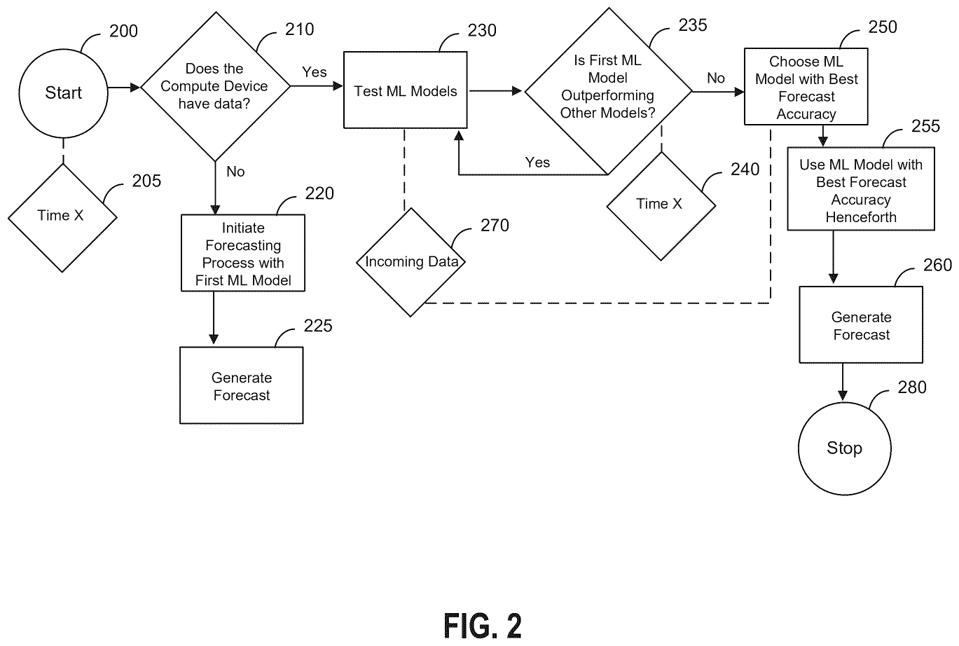

FIG. 2 illustrates a forecasting process for time series data during a cold-start period, in accordance with some examples described herein. In this example, a compute component may perform the process illustrated to forecast time series data that is forecast to be generated by a remote compute device or application. In some examples, the compute component executing machine readable instructions may be compute component 100 illustrated in FIG. 1 and the remote compute device or application may be compute device 130 in FIG. 1.

At block 200, the process may begin and proceed to block 205 and 210.

At block 205, the process determines Time X for the initial threshold estimation, denoted as “X_{0,j}.” The initial estimate may utilize historical time series data up to X_{0,j} for each compute device 130.

At block 210, the process may determine whether the compute device has sufficient data to proceed with forecasting. For example, the process can compare the available data to data volume thresholds. In other examples, the process may implement a feature diversity check or signal-to-noise ratio analysis to help ensure data quality and adequacy. If yes, the process proceeds to block 230. If no, the process proceeds to block 220.

At block 220, the process initiates a forecasting process using a first machine learning model. The first machine learning model may correspond with a forecasting using zero shot time series foundational model.

At block 225, the process generates a first forecast.

At block 230, the process provides the time series data from the compute device to other machine learning models. The forecasts generated by the multiple models may be compared to each other or to a threshold value to determine the performance of each of the models.

At block 235, the process determines whether the first model is performing better than other models. For example, the second machine learning model may outperform the first machine learning model when the forecast generated by the second machine learning model is more accurate than the forecast generated by the first machine learning model. In some examples, the second machine learning model may outperform other machine learning models based on an objective. The objective may correspond with minimizing a loss function, such as Mean Squared Error (MSE) or Mean Absolute Error (MAE), to generate forecasts as accurately as possible.

In other examples, the accuracy of the forecast may be compared with an accuracy threshold and the model corresponding with the accuracy value that exceeds the accuracy value may be selected to execute future forecast processes. The comparison may be implemented, for example, using a Root-Mean-Square Deviation (RMSE) to identify the differences in accuracy of the two models.

At block 240, the process updates Time X.

At block 250, the process utilizes the model with the best accuracy. For example, the process may continue using the first machine learning model to generate a forecast of the compute device or may switch to a second machine learning model to generate a forecast of the compute device.

At block 255, the process may use the machine learning model with the best forecast accuracy for the compute device henceforth.

At block 260, the process generates a second forecast.

At block 270, the process may receive additional time series data from compute device. The process may return to block 230.

At block 280, the process may end. In some examples, the process may stop based on a stopping criterion for determining when to stop forecasting with the first machine learning model and fully switch to the second machine learning model.

The stopping criteria may include surpassing a defined accuracy threshold or observing consistent performance improvements of the second machine learning model (e.g., within a threshold value) over a rolling time window.

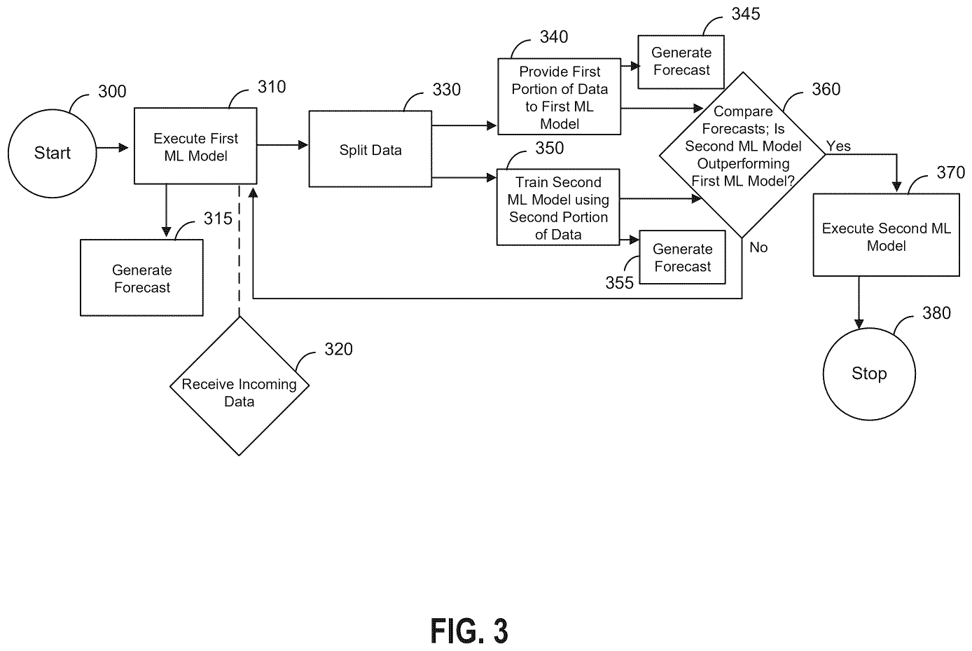

FIG. 3 illustrates a forecasting process for time series data during a cold-start period, in accordance with some examples described herein. In this example, a compute component may perform the process illustrated to forecast time series data that is forecast to be generated by a remote compute device or application. In some examples, the compute component executing machine readable instructions may be compute component 100 illustrated in FIG. 1 and the remote compute device or application may be compute device 130 in FIG. 1.

At block 300, the process may begin and proceed to block 310.

At block 310, the process initiates a forecasting process using a first machine learning model. The first machine learning model may correspond with a forecasting using zero shot time series foundational model.

At block 315, the process generates a forecast using the first machine learning model during a cold start period of a second machine learning model.

At block 320, the process may receive time series data from compute device. For example, the data may comprise time series data or telemetry data associated with the compute device in a computer environment, including data associated with the memory bus, Graphics Processing Unit (GPU), Central Processing Unit (CPU), or input/output (I/O), to list a few. In some examples, time series data may comprise temperature, humidity, or other sensor-detected values in the computer environment. The time series data may be effected by seasonality or other cyclical changes that are detectable in the data output generated by the compute device.

At block 330, the process may split the time series data from the compute device into two or more portions. Various splitting processes may be implemented. For example, thirty days of time series data associated with the compute device may be received and initially split into training, testing, and validation data. In another example, the amount of data may be open-ended and configurable by the user (e.g., stored in a profile). In some examples, the time series data may be split eighty-percent for training and twenty-percent for validation, or the data may be split sixty-percent for training, twenty-percent for testing, and twenty-percent for validation. In some examples, the time series data may be split using different cross-validation techniques that depend on the second machine learning model that is being trained/implemented.

In some examples, the splitting process may roll a training set window forward over time to split the data. The portions of data may correspond with the time series data within the window boundaries. The split data may overlap or occur in different portions of the time series data.

At block 340, the process may provide a first portion of the split data to the first machine learning model.

At block 345, the process generates a first forecast using the first machine learning model.

At block 350, the process may provide a second portion of the split data to the second machine learning model.

At block 355, the process generates a second forecast using the second machine learning model.

At block 360, the process may compare forecasts. The forecasts generated by the multiple models may be compared to each other or to a threshold value to determine the performance of each of the models. One of the models may be identified as outperforming the other model (e.g., exceeding an accuracy value, etc.).

At block 370, the process utilizes the second machine learning model. For example, the process may continue using the first machine learning model to generate a forecast of the compute device or may switch to a second machine learning model to generate a forecast of the compute device.

At block 380, the process may end. In some examples, the process may stop based on a stopping criterion for determining when to stop forecasting with the first machine learning model and fully switch to the second machine learning model. The stopping criteria may include surpassing a defined accuracy threshold or observing consistent performance improvements of the second machine learning model (e.g., within a threshold value) over a rolling time window.

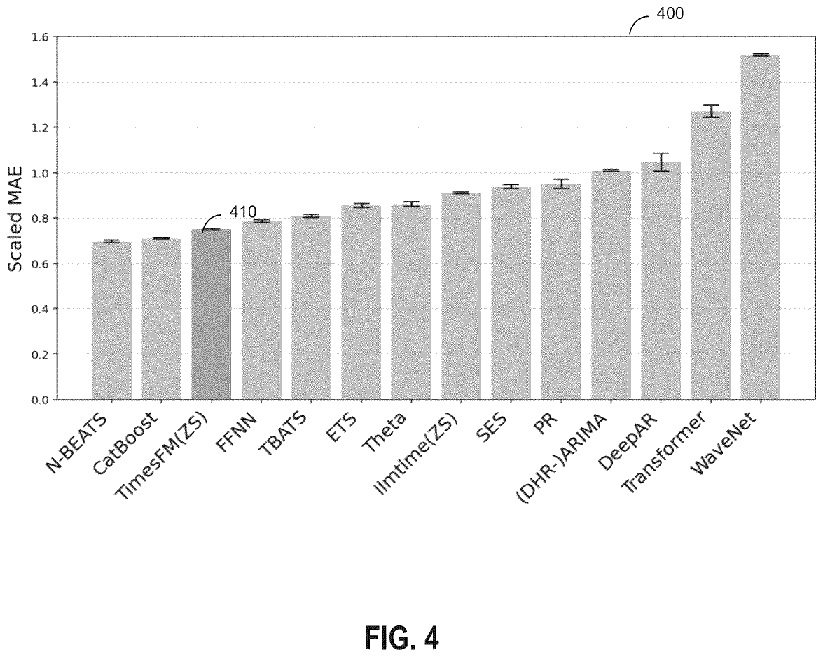

FIG. 4 illustrates a comparison of machine learning models, in accordance with some examples described herein. Chart 400 shows the forecast accuracy of several machine learning models on performing general forecast absent fine tuning. The second machine learning model is identified as model 410 in comparison with other models that perform general forecast absent fine tuning, referred to as the first machine learning model in the current system. Any of the models illustrated in chart 400 may be executed to generate a forecast during the cold start period for second model 410.

In some examples, forecasting accuracy may be implemented using an external process in order to determine whether one machine learning model outperforms the other models. For example, a Monash Forecasting Archive may contain tens of thousands of time series datasets from various domains like traffic, weather, and demand forecasting covering frequencies ranging from few minutes to yearly data. The models may be provided to the external process to determine the accuracy.

In some examples, the forecasting accuracy is determined using a mean absolute error (MAE) that has been scaled to compare similar amounts of data. The MAE may be averaged across the datasets. In this example, model 410 is outperforming most supervised approaches, including recent deep learning models. Model 410 may also be compared to specific prompting techniques proposed by Ilmtime(ZS) and generate forecasts with better accuracy despite being orders of magnitude smaller.

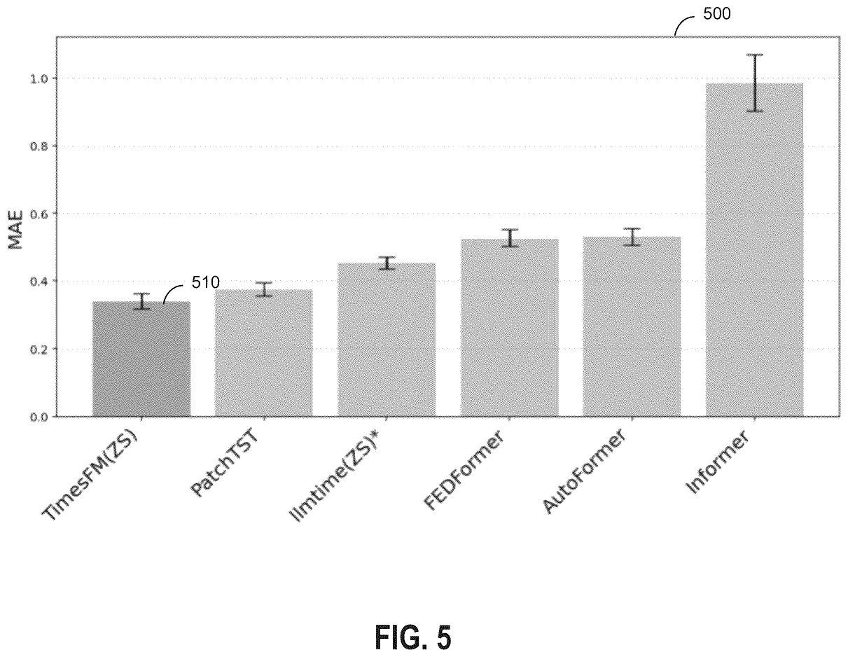

FIG. 5 illustrates a comparison of machine learning models, in accordance with some examples described herein. Chart 500 shows the forecast accuracy of several machine learning models on performing general forecast absent fine tuning. The second machine learning model is identified as model 510 in comparison with other models that perform general forecast absent fine tuning, referred to as the first machine learning model in the current system. Any of the models illustrated in chart 500 may be executed to generate a forecast during the cold start period for second model 510.

In some examples, forecasting accuracy is assessed for long-horizon forecasting and compared against other machine learning models. The MAE values for the machine learning models in FIG. 5 are compared for each model's accuracy in predicting 96 and 192 time-points into the future. The metric is calculated on the last test window of each dataset. The results demonstrate that model 510 outperforms several models.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

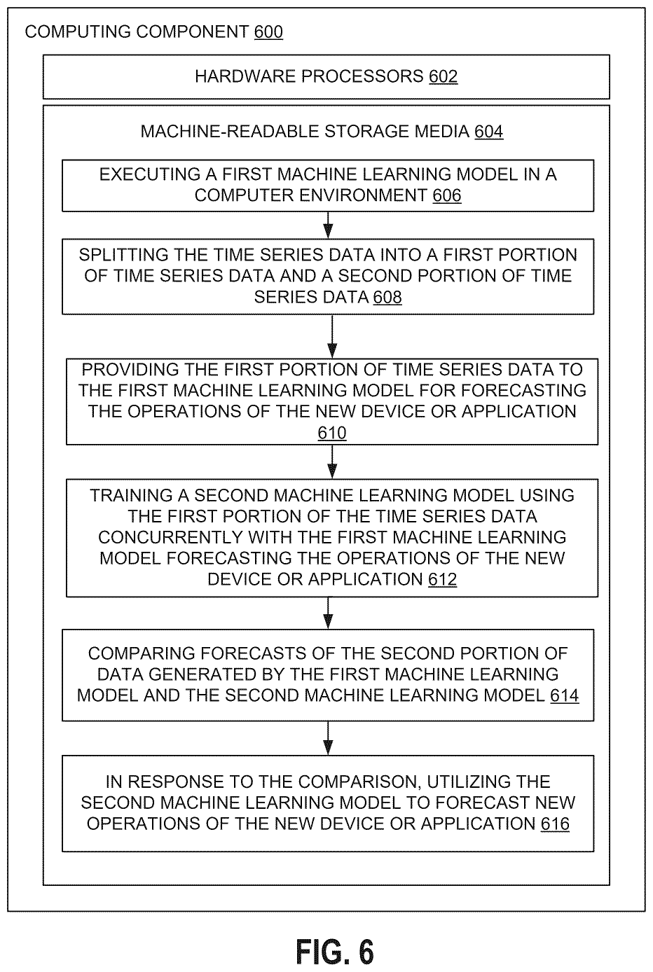

FIG. 6 illustrates a computing component that may be used to implement a forecast process for time series data during a cold-start period, in accordance with various examples of the disclosed technology. In this example, computing component 600 may be, for example, a server computer, a controller, or any other similar computing component capable of processing data. In the example implementation of FIG. 6, the computing component 600 includes hardware processor 602 and machine-readable storage medium 604.

Hardware processor 602 may be one or more central processing units (CPUs), graphics processing units (GPUs), semiconductor-based microprocessors, and/or other hardware devices suitable for retrieval and execution of instructions stored in machine-readable storage medium 604. Hardware processor 602 may fetch, decode, and execute instructions, such as instructions 606-616, to control processes or operations for forecasting time series data during a cold-start period. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-616.

Hardware processor 602 may execute instruction 606 to execute a first machine learning model in a computer environment. The first machine learning model may be configured to forecast operations of a new device or application that is activated in the computer environment. In some examples, the first machine learning model may correspond with a time series foundational model (TFM) that is trained on data outside of the computer environment and is configured to generalize forecasting for the new device or application.

Hardware processor 602 may execute instruction 608 to split the time series data into a first portion of time series data and a second portion of time series data. In some examples, the split is initiated in response to executing the first machine learning model and receiving time series data associated with the new device or application.

Hardware processor 602 may execute instruction 610 to provide the first portion of time series data to the first machine learning model for forecasting the operations of the new device or application. The first machine learning model may be executed absent fine tuning the model to the time series data in the computer environment, including time series data generated by the new device or application, in order to generate forecasting quickly.

Hardware processor 602 may execute instruction 612 to train a second machine learning model using the first portion of the time series data concurrently with the first machine learning model forecasting the operations of the new device or application. For example, the second machine learning model may be concurrently or additionally trained using data generated by the new device in the computer environment over a time period while the first model is generating the forecasting.

Hardware processor 602 may execute instruction 614 to compare forecasts regarding the second portion of time series data generated by the first machine learning model and the second machine learning model. The evaluation of the forecast performance can be compared using a Root Mean Square Error (RMSE) for both TFMs and ML models at X_{0,j}, denoted by RMSE_{TFM}(X_{0,j}) and RMSE_{ML}(X_{0,j}). In another example, the forecasts can be compared using historical data, real-time streaming validation, or scenario testing for hypothetical workload patterns.

Hardware processor 602 may execute instruction 616 to utilize the second machine learning model to forecast new operations of the new device or application in response to the comparison.

In some examples, feedback may be received to help refine Time X. The feedback mechanisms may include user-provided accuracy feedback, automatic performance monitoring using metrics like RMSE and MAPE, or iterative refinement of the second machine learning model through one or more feedback loops.

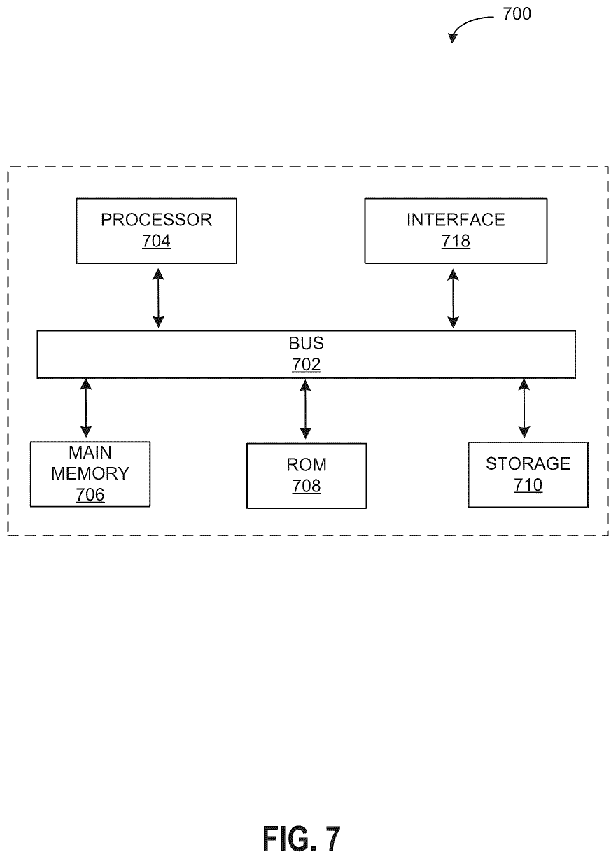

FIG. 7 depicts a block diagram of an example computer system 700 in which various examples of the disclosed technology described herein may be implemented. Computer system 700 includes bus 702 or other communication mechanism for communicating information, one or more hardware processors 704 coupled with bus 702 for processing information. Hardware processor(s) 704 may be, for example, one or more general purpose microprocessors.

Computer system 700 also includes main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes read only memory (ROM) 708 or other static storage device coupled to bus 702 for storing static information and instructions for processor 704. Storage device 710, such as a magnetic disk, optical disk, or USB thumb drive (Flash drive), etc., is provided and coupled to bus 702 for storing information and instructions.

Computer system 700 may include a user interface module to implement a GUI to provide to display. The user interface module may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 700 may implement the techniques described herein using customized hard-wired logic, one or more ASICs or FPGAs, firmware and/or program logic which in combination with the computer system causes or programs computer system 700 to be a special-purpose machine. According to one example of the disclosed technology, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

Computer system 700 also includes interface 718 coupled to bus 702. Interface 718 provides a two-way data communication coupling to one or more network links that are connected to one or more local networks. For example, interface 718 may be an integrated services digital network (ISDN) card, cable modem, satellite modem, or a modem to provide a data communication connection to a corresponding type of telephone line. As another example, interface 718 may be a local area network (LAN) card to provide a data communication connection to a compatible LAN (or WAN component to communicate with a WAN). Wireless links may also be implemented. In any such implementation, interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 718, which carry the digital data to and from computer system 700, are example forms of transmission media.

Computer system 700 can send messages and receive data, including program code, through the network(s), network link and interface 718. In the Internet example, a server might transmit a requested code for an application program through the Internet, the ISP, the local network and interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALS, CPLDs, FPGAS, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
executing a first machine learning model in a computer environment, the first machine learning model forecasting operations of a new device or application that is activated in the computer environment;
in response to executing the first machine learning model and receiving time series data associated with the new device or application:
splitting the time series data into a first portion of time series data and a second portion of time series data,
providing the first portion of time series data to the first machine learning model for forecasting the operations of the new device or application, and
training a second machine learning model using the first portion of the time series data concurrently with the first machine learning model forecasting the operations of the new device or application;
comparing forecasts regarding the second portion of time series data generated by the first machine learning model and the second machine learning model; and
in response to the comparison, utilizing the second machine learning model to forecast new operations of the new device or application.

2. The method of claim 1, wherein the first machine learning model is a time series foundational model (TFM).

3. The method of claim 1, further comprising:
executing the first machine learning model absent fine tuning the first machine learning model to the time series data in the computer environment.

4. The method of claim 1, wherein the comparison identifies that the second machine learning model outperforms the first machine learning model in forecasting the operations of the new device or application.

5. The method of claim 1, wherein the first machine learning model is used for forecasting the operations of the new device or application for a determined time period, and the method further comprises:
in response to exceeding the determined time period, retraining the second machine learning model with new time series data of the new device or application.

6. The method of claim 1, further comprising:
splitting the time series data into a third portion of time series data for validation of the first machine learning model, in addition to the first portion provided to the first machine learning model for forecasting and the second portion provided to the second machine learning model for training.

7. The method of claim 1, wherein the comparison of the forecasts generated by the first machine learning model and the second machine learning model are implemented using a Root-Mean-Square Deviation (RMSE).

8. The method of claim 1, further comprising:
comparing an accuracy value of the forecast of the second portion of data generated by the second machine learning model with a threshold value; and
in response to the accuracy value failing to exceed the threshold value, exponentially increasing a threshold time for initiating a second comparison of the forecasts.

9. A non-transitory computer-readable storage medium storing a plurality of instructions executable by a processor, the plurality of instructions when executed by the processor cause the processor to:
execute a first machine learning model in a computer environment, the first machine learning model forecasting operations of a new device or application that is activated in the computer environment;
in response to executing the first machine learning model and receiving time series data associated with the new device or application:
split the time series data into a first portion of time series data and a second portion of time series data,
provide the first portion of time series data to the first machine learning model for forecasting the operations of the new device or application, and
train a second machine learning model using the first portion of the time series data concurrently with the first machine learning model forecasting the operations of the new device or application;
compare forecasts regarding the second portion of time series data generated by the first machine learning model and the second machine learning model; and
in response to the comparison, utilize the second machine learning model to forecast new operations of the new device or application.

10. The non-transitory computer-readable storage medium of claim 9, wherein the first machine learning model is a time series foundational model (TFM).

11. The non-transitory computer-readable storage medium of claim 9, wherein the processor is further configured to:
execute the first machine learning model absent fine tuning the first machine learning model to the time series data in the computer environment.

12. The non-transitory computer-readable storage medium of claim 9, wherein the comparison identifies that the second machine learning model outperforming the first machine learning model in forecasting the operations of the new device or application.

13. The non-transitory computer-readable storage medium of claim 9, wherein the first machine learning model is used for forecasting the operations of the new device or application for a determined time period, and wherein the processor is further configured to:
in response to exceeding the determined time period, retrain the second machine learning model with new time series data of the new device or application.

14. The non-transitory computer-readable storage medium of claim 9, wherein the processor is further configured to:
split the time series data into a third portion of time series data for validation of the first machine learning model, in addition to the first portion provided to the first machine learning model for forecasting and the second portion provided to the second machine learning model for training.

15. The non-transitory computer-readable storage medium of claim 9, wherein the comparison of the forecasts generated by the first machine learning model and the second machine learning model are implemented using a Root-Mean-Square Deviation (RMSE).

16. The non-transitory computer-readable storage medium of claim 9, wherein the processor is further configured to:
compare an accuracy value of the forecast of the second portion of data generated by the second machine learning model with a threshold value; and
in response to the accuracy value failing to exceed the threshold value, exponentially increase a threshold time for initiating a second comparison of the forecasts.

17. A server comprising:
a memory storing instructions; and
a processor communicatively coupled to the memory and configured to execute the instructions to:
execute a first machine learning model in a computer environment, the first machine learning model forecasting operations of a new device or application that is activated in the computer environment;
in response to executing the first machine learning model and receiving time series data associated with the new device or application:
split the time series data into a first portion of time series data and a second portion of time series data,
provide the first portion of time series data to the first machine learning model for forecasting the operations of the new device or application, and
train a second machine learning model using the first portion of the time series data concurrently with the first machine learning model forecasting the operations of the new device or application;
compare forecasts regarding the second portion of time series data generated by the first machine learning model and the second machine learning model; and
in response to the comparison, utilize the second machine learning model to forecast new operations of the new device or application.

18. The server of claim 17, wherein the first machine learning model is a time series foundational model (TFM).

19. The server of claim 17, wherein the processor is further configured to:
execute the first machine learning model absent fine tuning the first machine learning model to the time series data in the computer environment.

20. The server of claim 17, wherein the comparison identifies that the second machine learning model outperforming the first machine learning model in forecasting the operations of the new device or application.
